(19) United States
(12) Patent Application Publication
(10) Pub. No.: US 2017/0053308 A1
(43) Pub. Date: Feb. 23, 2017

(54) POLICY-BASED, SUPPLY-SIDE AD REQUEST EDGE ROUTER

(71) Applicant: YuMe Inc., Redwood City, CA (US)

(72) Inventors: Ayyappan SANKARAN, San Jose, CA (US); Sachin GUPTA, Fremont, CA (US); Alok NANDAN, San Francisco, CA (US); Vijay KAUSHI, Fremont, CA (US)

(21) Appl. No.: 15/119,693

(22) PCT Filed: Feb. 24, 2015
(86) PCT No.: PCT/US15/17401

§ 371 Date: Aug. 17, 2016

Related U.S. Application Data
(60) Provisional application No. 61/943,673, filed on Feb. 24, 2014.

(51) Int. Cl. G06Q 30/02; H04L 29/06

(52) U.S. Cl. CPC G06Q 30/0248; H04L 63/0263; G06Q 30/0277

(57) ABSTRACT

A policy-based, supply-side ad request edge router includes a processor, a network interface coupled to the processor, and non-transitory computer-readable media including code segments executable on the processor to implement a routing method. In an embodiment, the routing method includes providing a policy plane including a plurality of policies P₁, . . . P_{N}, providing a data plane, receiving an ad request from a supply source via the network interface, imposing the policy plane on the data plane, and sending the ad request to at least one demand source based upon at least one of the plurality of policies.

### FIELD

This invention relates generally to systems and methods for efficiently delivering online advertisements.

### BACKGROUND

An online advertising (“ad”) network includes a server system that connects advertisers or advertising networks (“demand sources”) to publishers (“supply sources”) that want to display advertisements on connected screen devices such as personal computers (PCs), smartphones, Connected (Smart) Television (CTV or Smart TV), computer tablets, etc., that are connected to the Internet. A key function of an ad network is to aggregate ad space supply (“inventory”) of publishers and to match the inventory with advertiser demand.

A publisher has multiple ways to monetize their inventory. There are programmatic demand sources (such as Demand Side Platforms and trading desks) or non-programmatic demand sources (such direct sales, outsourced direct sales). A publisher/publisher network may not know the performance (revenue) that various demand sources might bring a priori.

A publisher ad platform (used to monetize ad inventory for a number of publishers) has the capability of routing ad requests to various demand sources depending on predetermined policies. However, in such routing tends to be inefficient in that it involves one or more intermediaries such as ad networks, ad exchanges, etc. (which are instances of “core routers”) rather than being routed more directly to routers near the ultimate demand sources. This loading of the core ad system is inefficient in that it takes additional time to process the ad requests and is expensive due to fees charged by the core routers.

These and other limitations of the prior art will become apparent to those of skill in the art upon a reading of the following descriptions and a study of the several figures of the drawing.

### SUMMARY

Various examples are set forth herein for the purpose of illustrating various combinations of elements and acts within the scope of the disclosures of the specification and drawings. As will be apparent to those of skill in the art, other combinations of elements and acts, and variations thereof, are also supported herein.

In an embodiment, set forth by way of example and not limitation, a policy-based, Supply-Side Ad Request (SSAR) edge router includes a policy plane including one or more policies and a data plane which implements the policies of the policy plane. An ad request from a supply is processed through the data plane to provide efficient, supply-side routing of the ad request.

In an embodiment, set forth by way of example and not limitation, a policy-based, supply-side ad request edge router includes a processor, a network interface coupled to the processor, and non-transitory computer-readable media including code segments executable on the processor for: providing a policy plane including a plurality of policies P₁ . . . P_{N}; providing a data plane; receiving an ad request from a supply source via the network interface; imposing the policy plane on the data plane; and sending the ad request to at least one demand source based upon at least one of the plurality of policies.

In an embodiment, set forth by way of example and not limitation, a method for operating a policy-based, supply-side ad request edge router including a processor and a network interface includes: providing a policy plane including a plurality of policies P₁ . . . P_{N}, providing a data plane, receiving an ad request from a supply source via the network interface, imposing the policy plane on the data plane, and sending the ad request to at least one demand source based upon at least one of the plurality of policies.

In an embodiment, set forth by way of example and not limitation, an online advertisement delivery system includes a supply source server coupled to the internet, a demand source server coupled to the interne, and a policy-based, supply-side ad request edge router coupled to the internet including: a processor, a network interface coupled to the processor, and non-transitory computer-readable media including code segments executable on the processor for: providing a policy plane including a plurality of policies P₁ . . . P_{N}; providing a data plane; receiving an ad request from a supply source via the network interface; imposing the policy plane on the data plane; and sending the ad request to at least one demand source based upon at least one of the plurality of policies.

It will be appreciated from the foregoing descriptions that a SSAR edge router includes many advantages for a publisher network. For example, a publisher network can assign a grade to certain subsets of inventory and then apply this grading policy to all ad requests for routing purposes; e.g. certain sites in certain geographies might yield better revenue if routed to non-programmatic demand sources). As another example, a publisher network may deem certain publisher(s) in its network as strategic and hence allocate a lion share of certain type of demand during certain specific time periods of the year to such publisher(s). Still further, a publisher network can apply a fraud detection policy applied to a subset of domains; e.g. certain APAC domains having a more aggressive fraud detection and containment policy than certain EU domains).

An advantage of certain example embodiments of a SSAR edge router include the ability to scale the overall ad platform to perform real-time ad decisions with respect to potentially billions of requests; front loading the mediation of ad requests to external destinations to prevent load on core ad infrastructure; detecting, characterizing and containing fraudulent ad requests at the edge of the ad infrastructure and performing remediation actions at the edge of the system (such as quarantine, blacklist, greylist etc.); providing an extensible policy framework to plug new business policies at publisher and publisher network level; and the provision of a high-level declarative DSL (domain specific language) to specify policies for different business tasks.

An advantage of example embodiments is that the SSAR edge router is capable of routing ad requests without impacting core ad routers of the advertising system. The results in the faster routing of ad requests to the proper demand sources and lowers costs by eliminating unnecessary intermediaries.

These and other examples of combinations of elements and acts supported herein as well as advantages thereof will become apparent to those of skill in the art upon a reading of the following descriptions and a study of the several figures of the drawing.

### BRIEF DESCRIPTION OF DRAWINGS

Several examples will now be described with reference to the drawings, wherein like elements and/or acts are provided with like reference numerals. The examples are intended to illustrate, not limit, concepts disclosed herein. The drawings include the following figures:

FIG. 1 illustrates an example network system including a Policy-Based, Supply-Side Ad Request Edge Router;

FIG. 2 is a block diagram of an example computer, computerized device, proxy and/or server which may form a part of the network system of FIG. 1;

FIG. 3 is a block diagram of an example Policy-Based, Supply-Side Ad Request Edge Router; and

FIG. 4 is a flow diagram of an example method for operating a policy-based, supply-side ad request edge router.

### DESCRIPTION OF EMBODIMENTS

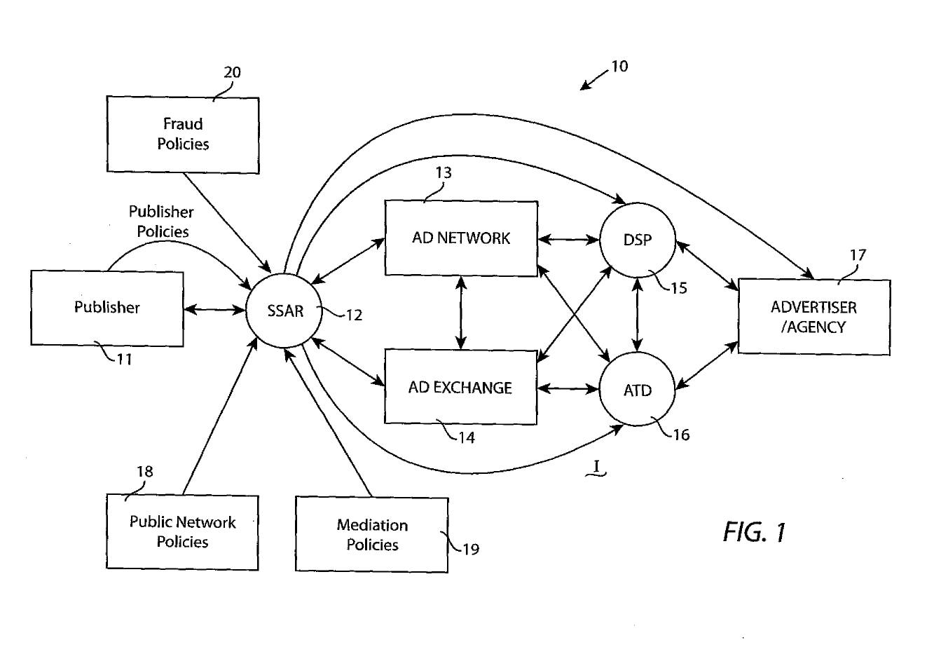

FIG. 1 illustrates an advertising network system 10, set forth by way of example and not limitation, including a publisher 11, a policy-based, Supply-Side Ad Request (SSAR) edge router 12, an ad network 13, an ad exchange 14, a Demand Side Platform (DSP) 15, an Advertising Trading Desk (ATD) 16, and Advertiser or Advertising Agency 17, Public Network Policies Source 18, a Mediation Policies Source 19, and a Fraud Polices Source 20. Some or all of advertising network system 10 is supported by an internet I or internet protocols on, for example, intranets.

In this non-limiting example, the SSAR edge router 12 receives an ad request from publisher 11 and then routes the request according to a set of policies. For example, policies can be from the Publisher 11, Public Network Policies 18, from the Mediation Policies 19 and/or from Fraud Policies 20.

As will be appreciated by those of skill in the art, a router operates at the third layer of the OSI (Open System Interconnect) Model, which is named the network layer. A router differentiates different networks to implement interconnection and isolation between networks and keep the independence of the individual networks. Most IP networks are of a layered architecture, i.e. all contain a packet-based core network and various types of access networks in order to achieve good manageability, stability and extensibility. The core network routes and switches packets in high speed, having high reliability and redundancy. An edge router locates at the egress of an access network and the ingress of a core network. A multiservice edge router typically has the capabilities of flow classification, traffic control (including metering, marking, dropping/shaping and queuing) and traffic aggregation.

Most routers have a plurality of stages of operation referred to as “planes.” In a control plane, a router maintains a routing table that lists which route should be used to forward a data packet, and through which physical interface connection. It does this using internal and pre-configured directives called static routes, or by learning routes using a dynamic routing protocol. Static and dynamic routes are stored in a Routing Information Base (RIB). The control plane logic strips the RIB from non-essential directives and builds a Forwarding Information Base (FIB) to be used by a forwarding or “data” plane.

A router forwards data packets between incoming and outgoing interface connections. It routes them to the correct network type using information contained in the packet headers and data recorded in the routing table control plane. The data plane defines the part of a router's architecture that decides what to do with packets arriving on an inbound interface. Most commonly, it refers to a table in which the router looks up the destination address of the incoming packet and retrieves the information necessary to determine the path from the receiving element, through the internal forwarding table of the router, and to the proper outgoing interface(s).

As will be appreciated by those of skill in the art, SSAR edge router 12 is a specialized form of edge router configured for advertising networks, e.g. one that is located at the edge of advertising network to connect, for example, with core ad routers of the advertising network. In the non-limiting example of FIG. 1, ad network 13 and ad exchange 14 can be considered core ad routers of advertising network 10. In other embodiments, DSP and ATD can be considered as core ad routers. In still further embodiments, more, less or different computers, servers, routers, etc. can be considered core ad routers.

In the example of FIG. 1, SSAR edge router 12 is placed at the edge of advertising network 10 including core ad routers (e.g. ad network 13 and ad exchange 14, in this non-limiting example) to route ad requests based on various policies. Additionally, some of the fraud ad request routing capability of SSAR edge router 12 is akin to an intranet “firewall.” By implementing its policies, the SSAR edge router 12 can direct ad requests of a publisher 11 to routers, such as DSP 15 and ATD 16, which are closer to the Advertiser/Agency 17 or even to the Advertiser/Agency itself, bypassing core ad routers such as Ad Network 13 and Ad Exchange 14.

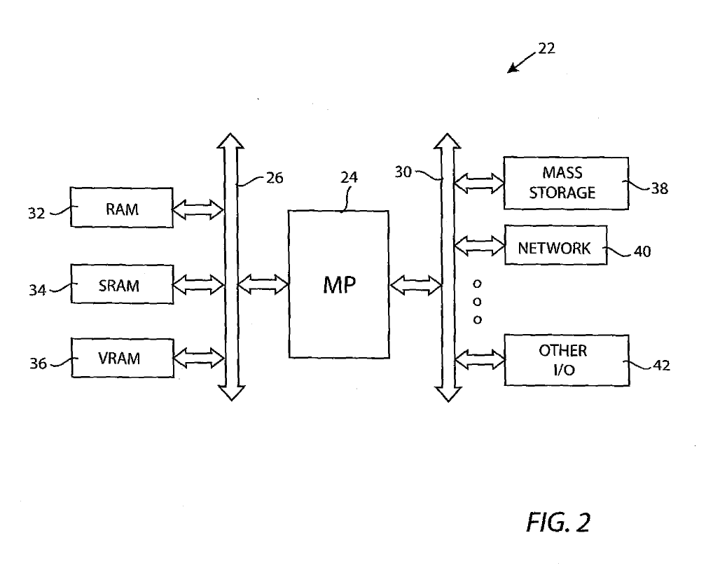

FIG. 2 is a simplified block diagram of a computer and/or server 22 suitable for use in network system 10, e.g. to provide the basic hardware environment in which example SSAR edge router 12 can operate. By way of non-limiting example, computer 22 includes a microprocessor (a/k/a “digital processor” and “processor”) 24 coupled to a memory bus 26 and an input/output (I/O) bus 30. A number of memory and/or other high speed devices may be coupled to memory bus 26 such as the RAM 32, SRAM 34 and VRAM 36. Attached to the I/O bus 30 are various I/O devices such as mass storage 38, network interface 40, and other I/O 42. As will be appreciated by those of skill in the art, there are a number of non-transitory computer readable media available to the microprocessor 24 such as the RAM 32, SRAM 34, VRAM 36 and mass storage 38. The network interface 40 and other I/O 42 also may also include computer readable media such as registers, caches, buffers, etc. Mass storage 38 can be of various types including hard disk drives, optical drives and flash drives, to name a few.

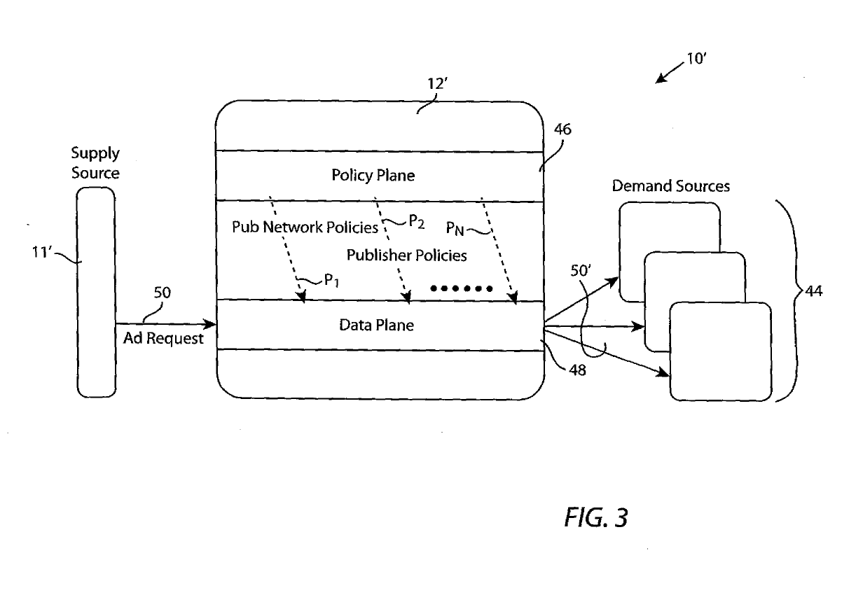

FIG. 3 is a block diagram of an advertising network system 10′, set forth by way of example and not limitation, including a supply source 11′, a SSAR edge router 12′ and a number of demand sources 44, which can include either or both of programmatic and non-programmatic demand sources. The SSAR edge router 12′ includes a policy plane 46, a data plane 48, and a number of policies P₁ . . . P_{N} imposed by the policy plane 46 on the data plane 48. For example, policy P₁ can be a Public Network Policy, policy P₂ can be a Publisher Policy, and P_{N} can be Fraud Policy. It will therefore be appreciated that data plane 48 can serve variously as a filter, firewall, packet processor and/or router as determined by the policies P₁ . . . P_{N}. That is, an ad request 50 is processed through data plane 48, under the influence of policies derived from the policy plane 46, to direct ad requests 50′ to one or more demand sources 44.

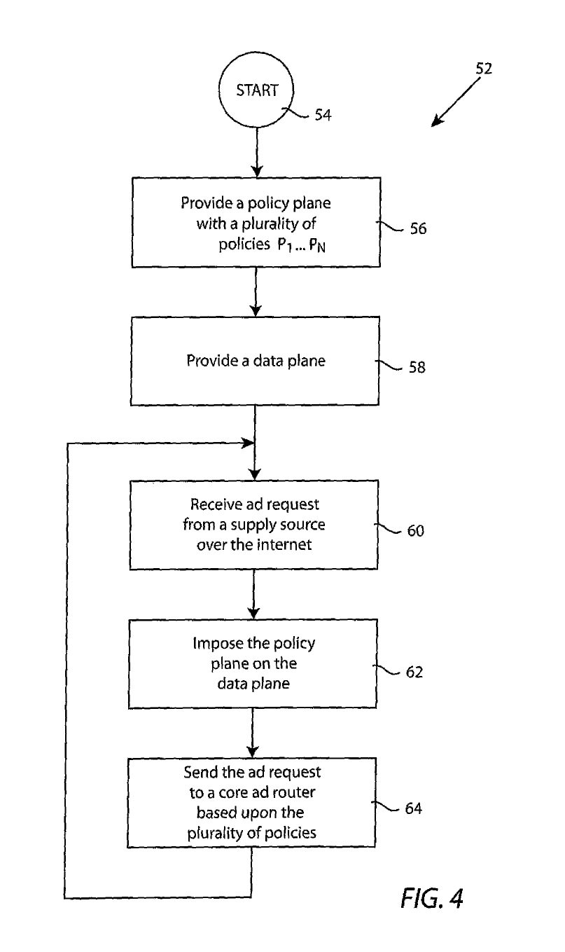

FIG. 4 is a flow diagram of an example method for operating a policy-based, supply-side ad request edge router as described with reference to FIGS. 1-3, above. The method (“process”) 52 begins at 54 and, in an operation 56, a policy plane including a plurality of policies P₁ . . . P_{N} is provided. Next, in an operation 58, a data plane is provided. Then, in an operation 60, an ad request is received from a supply source via a network interface. The policy plane is imposed on the data plane in an operation 62, and the ad request is sent to at least one selected demand source based upon the plurality of policies in operation 64. Process control then returns to operation 60 to await a new ad request. In other example embodiments other operations can take place, such as checking for policy updates, doing housekeeping, reporting, etc.

As noted above, there are a number of policy types that can be included in the policy plane of a SSAR edge router 12. For example, Mediation Policies 19 can include a recommendation engine, such as one that is disclosed in U.S. Ser. No. 61/900954, filed Nov. 6, 2013, entitled Mediation Recommendation Systems for Multiple Video Advertisement Demand Sources, which is incorporated herein by reference. As another example, Fraud Policies 20 can include spam IP databases, fraud IP databases, user identification databases, etc. which can be used to route, or block, ad requests appropriately. Also, information pertaining to individuals, households and network terminal identification can be provide as disclosed in U.S. Ser. No. 61/900,951 entitled Systems and Methods for Identifying Household Users of Electronic Screen Devices, and U.S. Ser. No. 61/900,955 entitled Methods and Systems for Network Terminal Identification, both filed on Nov. 6, 2013 and which are incorporated herein by reference.

Mediation Policies Source 19, for example, can include a reporting module and a recommendation module. A database can be used to store the outputs of the reporting model and the recommendation module for access by a mediation console. The database can also be used by a mediated target placement cache for targeted placements. The mediation module, in this non-limiting example, is coupled to the mediated target placement cache and to a mediation enablement front/back cache.

Example recommendation systems have a number of properties including: user preference; prediction accuracy; coverage (e.g. publisher/demand source); confidence; trust (e.g. show recommendation for few demand sources that a publisher already knows and likes to build trust in the recommendation system); novelty; serendipity (e.g. a measure of how surprising the successful recommendation is); diversity; utility (e.g. many e-commerce sites employ in order to improve revenue, but also can be diversity or serendipity); risk (e.g. expected revenue but also minimize risk); robustness (e.g., can the system be gamed?); privacy (e.g. do the publisher's preferences remain private?); adaptability; and scalability (e.g. can it scale to thousands of publishers and tens of demand sources per publisher). The recommendation system can therefore be used to implement Publisher Policies in a myriad of ways.

The use of policies utilizing the identification, by way of non-limiting examples, of individuals, groups and terminal devices can be very useful. For example, databases including household information can be used to implement certain policies on the SSAR edge router 12. By “household” it is generally meant a residential household including at least one, but often several, resident(s), although the term “household” can sometimes refer to other social groups, e.g. businesses or organizations which can include multiple screens and multiple members. Therefore, a “household” is a group of people that are socially related in some fashion. As another example, terminal information that can form the basis of a “fingerprint” for that terminal can be used in one or more policies of the SSAR edge router 12. By “terminal” it is meant a user device connected to the interne (“connected platform”), e.g. a personal computer, laptop, smartphone, tablet, etc. A “terminal fingerprint” can include a homogeneous set of fields that describe a specific user device at a specific point in time. In this example, the fields can be collected via a variety of mechanism. In certain embodiments, missing fields can be considered part of the fingerprint.

Although various embodiments have been described using specific terms and devices, such description is for illustrative purposes only. The words used are words of description rather than of limitation. It is to be understood that changes and variations may be made by those of ordinary skill in the art without departing from the spirit or the scope of various inventions supported by the written disclosure and the drawings. In addition, it should be understood that aspects of various other embodiments may be interchanged either in whole or in part. It is therefore intended that the claims be interpreted in accordance with the true spirit and scope of the invention without limitation or estoppel.

What is claimed is:

1. A policy-based, supply-side ad request edge router comprising:
a processor;
a network interface coupled to the processor; and
non-transitory computer-readable media including code segments executable on the processor for:
providing a policy plane including a plurality of policies P₁ . . . P_{N};
providing a data plane;
receiving an ad request from a supply source via the network interface;
imposing the policy plane on the data plane; and
sending the ad request to at least one demand source based upon at least one of the plurality of policies.

2. A policy-based, supply-side ad request edge router as recited in claim 1 wherein at least one of the plurality of policies P₁ . . . P_{N} is received via the network interface.

3. A policy-based, supply-side ad request edge router as recited in claim 2 wherein the plurality of policies includes Publisher Policies.

4. A policy-based, supply-side ad request edge router as recited in claim 3 wherein the Publisher Policies are received from the supply source.

5. A policy-based, supply-side ad request edge router as recited in claim 4 wherein the plurality of policies include Public Network Policies.

6. A policy-based, supply-side ad request edge router as recited in claim 5 wherein the plurality of policies include Fraud Policies.

7. A policy-based, supply-side ad request edge router as recited in claim 6 wherein the plurality of policies include Mediation Policies.

8. A policy-based, supply-side ad request edge router as recited in claim 7 wherein the Mediation Policies include a recommendation engine.

9. A policy-based, supply-side ad request edge router as recited in claim 8 wherein the at least one demand source includes at least one core ad router.

10. A method for operating a policy-based, supply-side ad request edge router including a processor and a network interface comprising:
providing a policy plane including a plurality of policies P₁ . . . P_{N};
providing a data plane;
receiving an ad request from a supply source via the network interface;
imposing the policy plane on the data plane; and
sending the ad request to at least one demand source based upon at least one of the plurality of policies.

11. A method for operating a policy-based, supply-side ad request edge router as recited in claim 10 wherein at least one of the plurality of policies P₁ . . . P_{N} is received via the network interface.

12. A method for operating a policy-based, supply-side ad request edge router as recited in claim 11 wherein the plurality of policies includes Publisher Policies.

13. A method for operating a policy-based, supply-side ad request edge router as recited in claim 12 wherein the Publisher Policies are received from the supply source.

14. A method for operating a policy-based, supply-side ad request edge router as recited in claim 13 wherein the plurality of policies include Public Network Policies.

15. A method for operating a policy-based, supply-side ad request edge router as recited in claim 14 wherein the plurality of policies include Fraud Policies.

16. A method for operating a policy-based, supply-side ad request edge router as recited in claim 15 wherein the plurality of policies include Mediation Policies.

17. A method for operating a policy-based, supply-side ad request edge router as recited in claim 16 wherein the Mediation Policies include a recommendation engine.

18. A method for operating a policy-based, supply-side ad request edge router as recited in claim 17 wherein the at least one demand source includes at least one core ad router.

19. An online advertisement delivery system comprising:
a supply source server coupled to the internet;
a demand source server coupled to the internet; and
a policy-based, supply-side ad request edge router coupled to the internet including:
a processor;
a network interface coupled to the processor; and
non-transitory computer-readable media including code segments executable on the processor for:
providing a policy plane including a plurality of policies P₁ . . . P_{N};
providing a data plane;
receiving an ad request from a supply source via the network interface;
imposing the policy plane on the data plane; and
sending the ad request to at least one demand source based upon at least one of the plurality of policies.

20. An online advertisement delivery system as recited in claim 19 wherein the supply source server comprises a publisher and the demand source server comprises a core ad router.
